(19) United States
(12) Patent Application Publication
(10) Pub. No.: US 2011/0042908 A1
(43) Pub. Date: Feb. 24, 2011

(54) ADJUSTABLE HEIGHT SUSPENSION SYSTEM

(75) Inventor: Christian Nolin, Sherbrooke (CA)

Correspondence Address: OSLER, HOSKIN & HARCOURT LLP (BRP), 2100 - 1000 DE LA GAUCHETIERE ST. WEST, MONTREAL, QC, H3B4W5, CA

(73) Assignee: BOMBARDIER RECREATIONAL PRODUCTS INC., VALCOURT, QC (CA)

(21) Appl. No.: 12/989,762

(22) PCT Filed: Apr. 30, 2008
(86) PCT No.: PCT/US08/62040

§ 371 Date: Oct. 26, 2010

(51) Int. Cl. B60G 17/017

(52) U.S. Cl. 280/6.157

(57) ABSTRACT

An adjustable height suspension system for a vehicle is disclosed. A pivot arm has a first end pivotably connected to the vehicle frame about a pivot axis. A shock absorber assembly is connected to the frame at a first connection point and connected to the pivot arm at a second connection point. An air spring is connected to the frame at a third connection point and connected to the pivot arm at a fourth connection point. The fourth connection point is closer to the pivot axis than the second connection point. The air spring has at least one inlet and at least one outlet provided by at least one opening. A valve selectively communicates the interior of the air spring to the atmosphere via the outlet. An adjustable height suspension system having first and second pivot arms and first and second air springs is also described.

### FIELD OF THE INVENTION

The present invention relates to adjustable height suspension systems.

### BACKGROUND OF THE INVENTION

Motorized vehicles, such as motorcycles, all-terrain vehicles (ATVs) and three-wheeled road vehicles, are driven by a propulsion device, typically either one or more driven wheels or a drive track, which is powered by an internal combustion engine. These vehicles are sometimes used on either bumpy roads or rough off-road terrain. In these operating conditions, the forces due to the impacts between the terrain and the propulsion device are transferred through the frame to the driver and passengers, which can make the riding experience uncomfortable, especially over long distances. This is especially true when the vehicle can carry multiple passengers as it is difficult to calibrate the suspension adequately for all loading conditions.

In an effort to minimize the transfer of these forces to the driver and passengers, most of today's commercially available motorized vehicles have some form of suspension system, such as a spring and a shock absorber, disposed either between the seat and the frame of the vehicle or between the frame and the propulsion device.

One concern when designing a suspension system for vehicles such as motorcycles, ATVs and three-wheeled road vehicles is that the weight of the driver, passengers, and/or cargo will have a large impact on the performance of the suspension. In other vehicles such as cars, for example, the frame, engine, fuel tank, and seat, to name a few, are all suspended on the wheels of the car. Since the suspended mass is relatively large, the mass of the driver, the presence or absence of passengers and/or cargo is only a small percentage of the suspended mass of the car, and has little effect. As such, the suspensions for cars can be designed for one suspended mass (suspended mass of vehicle plus an estimated mass to take into account loading of the vehicle) and will operate adequately regardless of the mass of the driver, the presence or absence of passengers and/or cargo.

In vehicles such as motorcycles, ATVs, and three-wheeled road vehicles, the overall mass of the vehicle is considerably lighter. As a result, the suspended mass is considerably lighter, and may be comparable to the mass of the driver, passengers and cargo. Thus, the weight of the driver, passengers and cargo, and in particular the presence or absence of passengers or cargo, has a significant effect on the suspended mass. The suspensions of these vehicles need to accommodate these larger variations.

Using a spring that has a low spring rate will cause the suspension to operate adequately when only a driver is present on the vehicle, but may cause the suspension to operate less effectively when passengers and cargo are also on the vehicle. Using a spring having a high spring rate will cause the suspension to operate adequately when a driver, passenger, and cargo are on the deck, but will be too stiff when only a driver is present, thus not absorbing the forces as effectively and reducing the enjoyment of the driver.

In addition, a suspension assembly is generally calibrated to have particular riding characteristics based on a particular initial length of the suspension assembly and the stroke length of the suspension assembly. The length of the suspension assembly is a function of the geometry of the vehicle, including the ride height of the vehicle, and where and how the suspension assembly is connected to the vehicle. The stroke length is a function of the geometry of the suspension assembly, specifically the maximum amount of space available before two parts of the suspension assembly contact each other and prevent further movement. When the suspension assembly is initially at the ride height for which it has been calibrated, it can give the desired riding characteristics throughout its stroke length.

For example, the suspension assembly may be calibrated for the initial length when only a rider of average weight is seated on the vehicle. If the load placed on the suspension system is increased, for example if the driver is heavier than average or there are passengers or cargo on the vehicle, the ride height will be reduced. As a result, there will be less stroke available for the suspension system to absorb large bumps without bottoming out. In addition, the spring will be compressed from its intended initial position, requiring more force to compress it further and resulting in a harsher suspension that will transmit more impacts to the passengers. In addition, in the case of a position-sensitive shock absorber, if the ride height is lower than the calibrated ride height, the shock absorber will not perform as intended.

A number of conventional methods have been used to maintain a relatively constant ride height. One such method involves altering the length of the spring by adjusting the position of one end of the spring relative to the shock absorber. While this method maintains a relatively constant ride height, it alters the preload of the spring, which alters the behaviour of the suspension system. In particular, altering the preload of the spring does not alter the effective spring constant of the suspension system. However, the additional mass that necessitates the adjustment increases the suspended mass, which lowers the natural frequency of oscillation of the suspended mass. A higher natural frequency produces a stiffer suspension, and a lower natural frequency produces a softer suspension. Thus, adding to the suspended mass of the vehicle alters the riding experience in a way that may adversely affect the enjoyment of the riders. Another method is to add or remove oil from the shock absorber. While this method maintains a relatively constant ride height, it alters the calibration of the shock absorber.

Therefore, there is a need for a suspension system wherein the ride height and the calibration of the suspension assembly are kept relatively constant for a wide range of applied loads.

### SUMMARY OF THE INVENTION

It is an object of the present invention to ameliorate at least some of the inconveniences present in the prior art.

In one aspect, the invention provides an adjustable height suspension system for a vehicle, comprising a frame. A pivot arm has a first end pivotably connected to the frame. The pivot arm is pivotable with respect to the frame about a pivot axis. The adjustable height suspension system comprises a shock absorber assembly having a first end connected to the frame at a first connection point and a second end connected to the pivot arm at a second connection point. A length of the shock absorber assembly changes as the pivot arm pivots with respect to the frame. The shock absorber assembly comprises a shock absorber. An air spring has a first end connected to the frame at a third connection point and a second end connected to the pivot arm at a fourth connection point. A length of the air spring changes as the pivot arm pivots with respect to the frame. The fourth connection point is closer to the pivot axis than the second connection point. The air spring has an interior. The air spring has at least one inlet and at least one outlet provided by at least one opening. A valve selectively communicates the interior of the air spring to the atmosphere via the outlet.

In a further aspect, the third connection point is closer to the pivot axis than the first connection point.

In a further aspect, a compressor communicates with the interior of the air spring via the inlet to supply air to the interior of the air spring.

In a further aspect, a position sensor is connected to the vehicle. The position sensor is operative to detect a relative position of the frame and the pivot arm.

In a further aspect, a controller is connected to the vehicle. The controller is operative to receive a signal from the position sensor indicative of the relative position of the frame and the pivot arm. The controller selectively activates one of the valve and the compressor at least in part as a function of the signal.

In a further aspect, the controller activates the valve when the signal received is indicative of a ride height higher than a predetermined ride height. The controller activates the compressor when the signal received is indicative of a ride height lower than a predetermined ride height.

In a further aspect, the controller activates the valve when the signal received is indicative of a ride height higher than the predetermined ride height by a first predetermined threshold height. The controller activates the compressor when the signal received is indicative of a ride height lower than the predetermined ride height by a second predetermined threshold height.

In a further aspect, the valve provides selective communication between the compressor and the interior of the air spring.

In a further aspect, the pivot arm has a second end opposite the first end, the second end being adapted to connect to a wheel.

In an additional aspect, the invention provides an adjustable height suspension system for a vehicle, comprising a frame. First and second pivot arms each have a first end pivotably connected to the frame. The first and second pivot arms are pivotable with respect to the frame about respective first and second pivot axes. The adjustable height suspension system comprises a first shock absorber assembly having a first end connected to the frame at a first connection point and a second end connected to the first pivot arm at a second connection point. A length of the first shock absorber assembly changes as the first pivot arm pivots with respect to the frame. The first shock absorber assembly comprises a first shock absorber. A first air spring has a first end connected to the frame at a third connection point and a second end connected to the first pivot arm at a fourth connection point. A length of the first air spring changes as the first pivot arm pivots with respect to the frame. The fourth connection point is closer to the first pivot axis than the second connection point. The first air spring has an interior. The first air spring has at least one first inlet and at least one first outlet provided by at least one first opening. A second shock absorber assembly has a first end connected to the frame at a fifth connection point and a second end connected to the second pivot arm at a sixth connection point. A length of the second shock absorber assembly changes as the second pivot arm pivots with respect to the frame. The second shock absorber assembly comprises a second shock absorber. A second air spring has a first end connected to the frame at a seventh connection point and a second end connected to the second pivot arm at an eighth connection point. A length of the second air spring changes as the second pivot arm pivots with respect to the frame. The eighth connection point is closer to the second pivot axis than the sixth connection point. The second air spring has at least one second inlet and at least one second outlet provided by at least one second opening. At least one valve selectively communicates the interior of the first and second air springs to the atmosphere via the first and second outlets, respectively.

In a further aspect, the third connection point is closer to the first pivot axis than the first connection point. The seventh connection point is closer to the second pivot axis than the fifth connection point.

In a further aspect, a compressor communicates with the interiors of the first and second air springs via the first and second inlets respectively, to supply air to the interiors of the first and second air springs.

In a further aspect, a first position sensor is connected to the vehicle. The first position sensor is operative to detect a relative position of the frame and the first pivot arm. A second position sensor is connected to the vehicle. The second position sensor is operative to detect a relative position of the frame and the second pivot arm.

In a further aspect, a controller is connected to the vehicle. The controller is operative to receive a signal from each position sensor indicative of the relative position of the frame and the corresponding pivot arm. The controller selectively activates one of the valve and the compressor at least in part as a function of the signal.

In a further aspect, the controller activates the valve when the signal received is indicative of a ride height higher than a predetermined ride height. The controller activates the compressor when the signal received is indicative of a ride height lower than a predetermined ride height.

In a further aspect, the controller activates the valve when the signal received is indicative of a ride height higher than the predetermined ride height by a first predetermined threshold height. The controller activates the compressor when the signal received is indicative of a ride height lower than the predetermined ride height by a second predetermined threshold height.

In a further aspect, the valve provides selective communication between the compressor and the interior of the first and second air springs.

In a further aspect, each pivot arm has a second end opposite the first end. The second end is adapted to connect to a wheel.

In a further aspect, the at least one valve is a single valve.

For purposes of this application, terms related to spatial orientation such as “forwardly”, “rearwardly”, right and left are defined with respect to a forward direction of travel of the vehicle, and should be understood as they would be understood by a rider sitting on the vehicle in a normal riding position. In addition, the term “air spring” refers to a sealed body or compartment into which compressed air can be provided, and which can use the pressurized air to support a weight and absorb shocks.

Embodiments of the present invention each have at least one of the above-mentioned objects and/or aspects, but do not necessarily have all of them. It should be understood that some aspects of the present invention that have resulted from attempting to attain the above-mentioned objects may not satisfy these objects and/or may satisfy other objects not specifically recited herein.

Additional and/or alternative features, aspects, and advantages of embodiments of the present invention will become apparent from the following description, the accompanying drawings, and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 is a side elevation view of an ATV;

FIG. 2 is a side elevation view of a three-wheeled motorized vehicle;

FIG. 3 is a side elevation view of the rear suspension system of the three-wheeled motorized vehicle of FIG. 3;

FIG. 4 is a perspective view, taken from a rear, left side, of the rear suspension system of the ATV of FIG. 2;

FIG. 5 is a perspective view, taken from a rear, right side, of the rear suspension system of the ATV of FIG. 2, showing additional components of the suspension system;

FIGS. 6-9 are side elevation views of the rear suspension system of FIG. 4, showing different heights of the rear suspension system.

### DETAILED DESCRIPTION OF THE PREFERRED EMBODIMENTS

An adjustable height suspension system in accordance with embodiments of the present invention will be described with respect to its use with ATVs and three-wheeled motorized vehicles. However, it should be understood that the present invention could also be applied to other types of vehicles having suspension systems, such as motorcycles and personal watercraft.

There will now be described an ATV 200 to which the method of the present invention can be applied.

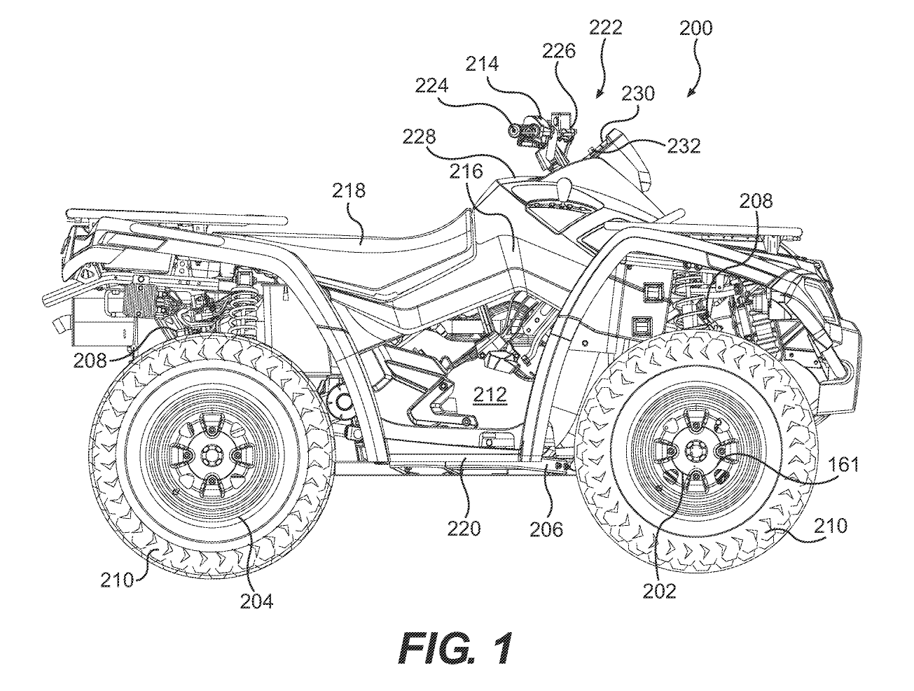

FIG. 1 is a side elevation view of the ATV 200. The ATV 200 has two laterally spaced front wheels 202 and two laterally spaced rear wheels 204, each mounted on the frame 206 via a suspension assembly 208. Each of the front wheels 202 and the rear wheels 204 has mounted thereon a low-pressure balloon tire. The front wheels are each provided with a brake (not shown) for braking the ATV in a known manner. The rear wheels 204 are powered by an engine 212 (schematically illustrated) via a transmission (not shown) to propel the vehicle. The frame 206 supports a body composed of a number of fairings 216 which provide aesthetic appeal and protect the rider from dirt and water that may be lifted by the tires while the vehicle is in use.

A straddle seat 218 mounted on the frame 206 provides a seating position for a rider. The ATV 200 may also have a second seating position for a passenger. A pair of footrests 220 is provided below the seat 218 for the rider to rest his feet thereon.

A steering assembly 222 is provided generally forward of the seat 218. The steering assembly has a pair of handlebars 224 that can be gripped by a rider. The handlebars 224 are connected to a steering column 226. The steering assembly 222 is connected to the front wheels 202 in a known manner, such that turning the handlebars 224 turns the front wheels 202 to steer the ATV 200.

There will now be described a three-wheeled motorized vehicle 300 to which the method of the present invention can be applied.

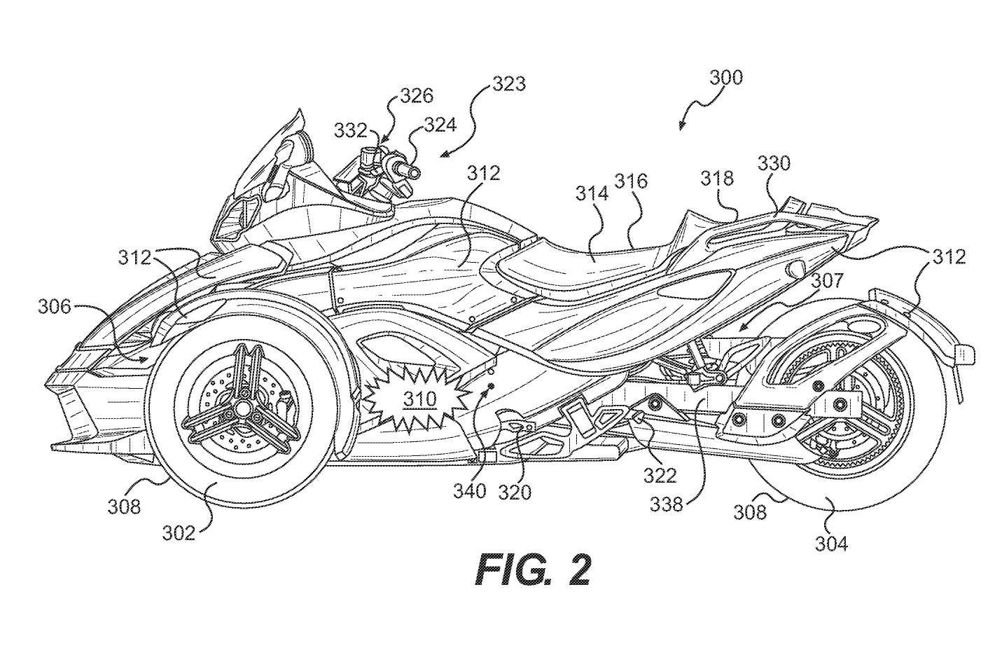

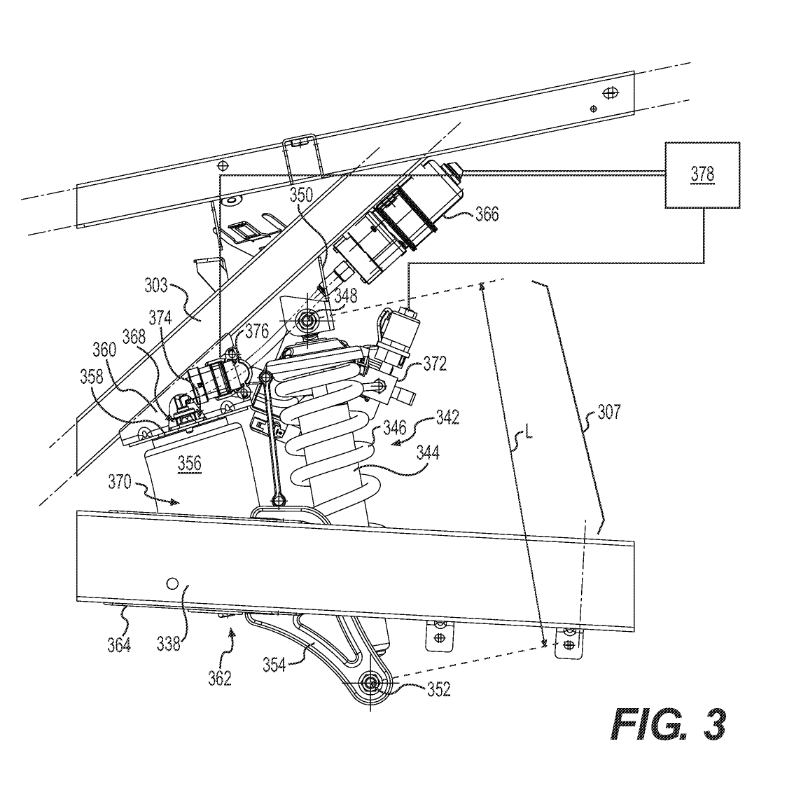

FIG. 2 is a side elevation view of a three-wheeled motorized vehicle 300. The vehicle 300 has two laterally spaced front wheels 302 and a single rear wheel 304. The front wheels 302 are mounted on the frame 303 (best seen in FIG. 3), via a front suspension assembly 306. The rear wheel 304 is mounted on the frame 303 via a rear suspension assembly 307 that will be discussed below in further detail. Each of the front wheels 302 and the rear wheel 304 has mounted thereon a tire 308 suitable for road use. It is contemplated that the rear wheel 304 may have two or more tires disposed next to each other mounted thereon and still be considered a single wheel. The front and rear wheels 302, 304 are each provided with a brake (not shown). The rear wheel 304 is powered by an engine 310 (schematically illustrated) via a transmission (not shown) to propel the vehicle 300. The vehicle frame supports a body composed of a number of fairings 312 which provide aesthetic appeal and protect the rider from dirt and water that may be lifted by the tires while the vehicle is in use.

A straddle seat 314 mounted on the frame provides a first seating position 316 for a rider, and a second seating position 318 for a passenger. The vehicle 300 may alternatively have only a single seating position 316 for the rider. A pair of grab handles 330 is provided to be gripped by the passenger. A pair of rider foot pegs 320 and a pair of passenger foot pegs 322 are provided below the seat 314 for the rider and passenger, respectively, to rest their feet thereon.

A steering assembly 323 is provided generally forward of the seat 314. The steering assembly 323 has a left handlebar 324 and a right handlebar 326 that can be gripped by a rider. The handlebars 324, 326 are connected to a steering column 328. The steering assembly 323 is connected to the front wheels 302 in a known manner, such that turning the handlebars 324, 326 turns the wheels 302 to steer the vehicle. A brake actuator, in the form of a hand brake lever 332, is provided near the left handlebar 324 for braking the vehicle 300.

Referring now to FIG. 3, the rear suspension assembly 307 of the three-wheeled vehicle 300 will be described. The suspension assembly 307 is connected between the frame 303 and a pivot arm in the form of a swing arm 338. The forward end of the swing arm 338 is pivotably connected to the frame 303 and can pivot with respect thereto about a pivot axis 340. The rear wheel 304 is supported on the swing arm 338, such that when the wheel 304 encounters a bump or other obstacle the swing arm 338 pivots relative to the frame 303 about the pivot axis 340 (seen in FIG. 2) and compresses the suspension assembly 307. The relative movement is partially absorbed by the suspension assembly 307 to reduce the transmission of the impact to the rider, as will be discussed below in further detail.

The suspension assembly 307 includes a shock absorber assembly 342 consisting of a shock absorber 344 and a coil spring 346. It is contemplated that the coil spring 346 may be omitted. A first end 348 of the shock absorber assembly 342 is connected to the frame 303 via a bracket 350, and a second end 352 of the shock absorber assembly 342 is connected to the swing arm 338 via a bracket 354 in the form of a cross member. The shock absorber assembly 342 is calibrated in a known manner to have a desired performance when the vehicle is initially at a desired ride height, corresponding to a length L of the shock absorber assembly 342.

The suspension assembly 307 also includes an air spring 356. A first end 358 of the air spring 356 is connected to the frame 303 via a bracket 360 such that the first end 358 of the air spring 356 is closer to the axis 340 than the first end 348 of the shock absorber assembly 342. A second end 362 of the air spring 356 is connected to the swing arm 338 via a bracket 364 such that the second end 362 of the air spring 356 is closer to the axis 340 than the second end 352 of the shock absorber assembly 342. As a result, the air spring 356 is positioned closer to the axis 340 than is the shock absorber assembly 342, at a location where the frame 303 is closer to the swing arm 338, and the changes in distance between the frame 303 and the swing arm 338 are correspondingly smaller. As a result, a relatively short air spring 356 can be used. The shorter air spring 356 has more lateral stability and can exert a greater force than a longer air spring without buckling, while minimizing the amount of weight added to the vehicle 300 by the air spring 356.

An air compressor 366 is connected to an inlet 368 of the air spring 356 for supplying air to the interior 370 of the air spring 356 via the inlet 368. It is contemplated that any suitable mechanism may alternatively be used to supply air to the interior 370 of the air spring 356, such as a manual pump operated by the rider. A valve 372, in the form of a solenoid valve, communicates with the interior 370 of the air spring 356 via an outlet 374, for releasing air from the interior 370 of the spring 356 to the atmosphere. It is contemplated that the valve 372 may alternatively be any other suitable valve, such as a manually operated valve. It is further contemplated that the inlet 368 may alternatively function as both the inlet and the outlet, and that the valve 372 may be a two-way valve capable of selectively communicating the interior 370 of the air spring 356 with either the compressor 366 or the atmosphere as required.

A position sensor 376 is connected between the frame 303 and the swing arm 338. The position sensor 376 detects the relative position of the frame 303 and the swing arm 338, and sends an electronic signal to a controller 378 (shown schematically) to indicate either the relative position of the frame 303 and the swing arm 338, or a change in the relative position. The controller 378 is capable of sending a signal to either the compressor 366 or the valve 372 as a function of the electronic signal received from the position sensor 376, as will be described below in further detail. It is contemplated that the position sensor 376 may alternatively be a mechanical indicator that indicates the relative position directly to the rider, for example by way of a visible gauge or one or more reference heights indicated on the vehicle 300. A mechanical indicator would be suitable in the case where a manual pump is used by the rider to supply air to the interior 370 of the air spring 356.

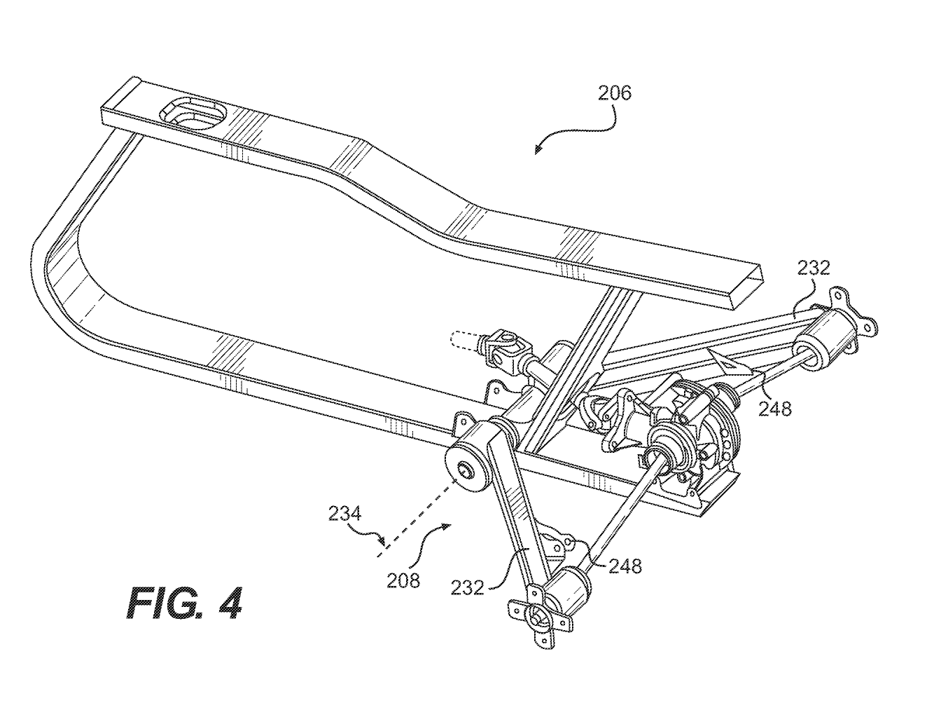

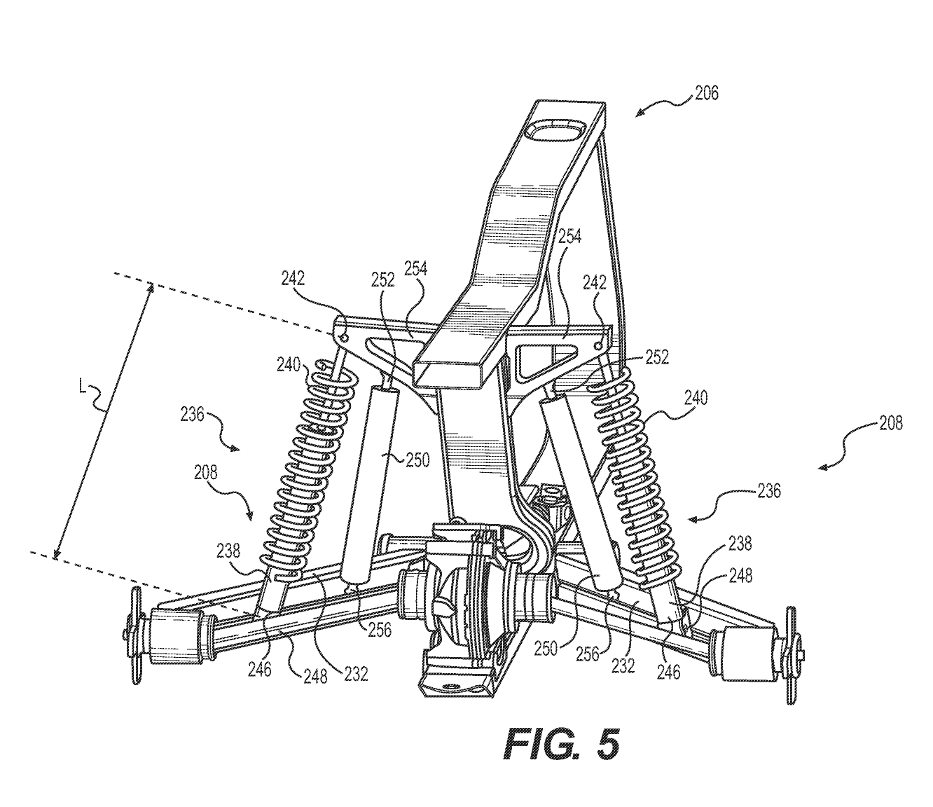

Referring now to FIGS. 4 and 5, the rear suspension assembly 208 of the ATV 200 will be described. The suspension assembly 208 is connected between the frame 206 and a pivot arm in the form of a swing arm 232. The forward ends of the swing arms 232 are pivotably connected to the frame 206 and can pivot with respect thereto about a pivot axis 234. The rear wheels 204 are supported on the swing arms 232, such that when one of the wheels 204 encounters a bump or other obstacle the corresponding swing arm 232 pivots relative to the frame 206 about the pivot axis 234. The relative movement is partially absorbed by the suspension assembly 208 to reduce the transmission of the impact to the rider, as will be discussed below in further detail.

The suspension assembly 208 includes a shock absorber assembly 236 consisting of a shock absorber 238 and a coil spring 240. It is contemplated that the coil spring 240 may be omitted. A first end 242 of the shock absorber assembly 236 is connected to the frame 206 via a bracket 244, and a second end 246 of the shock absorber assembly 236 is connected to the swing arm 232 via a bracket 248. The shock absorber assembly 236 is calibrated in a known manner to have a desired performance when the vehicle is initially at a desired ride height, corresponding to a length L of the shock absorber assembly 236.

The suspension assembly 208 also includes an air spring 250. A first end 252 of the air spring 250 is connected to the frame 206 via a bracket 254 such that the first end 252 of the air spring 250 is closer to the axis 234 than the first end 242 of the shock absorber assembly 236. A second end 256 of the air spring 250 is connected to the swing arm 232 such that the second end 256 of the air spring 250 is closer to the axis 234 than the second end 246 of the shock absorber assembly 236. As a result, the air spring is positioned closer to the axis 236 than is the shock absorber assembly 236. In this position, the frame 206 is closer to the swing arm 232, and the changes in distance between the frame 206 and the swing arm 232 are correspondingly smaller. As a result, a relatively short air spring 250 can be used. The shorter air spring 250 has more lateral stability and can exert a greater force than a longer air spring without buckling, while minimizing the amount of weight added to the vehicle 200 by the air spring 250.

An air compressor (not shown) is connected to an inlet (not shown) of the air spring 250 for supplying air to the interior of the air spring 250 via the inlet. It is contemplated that any suitable mechanism may alternatively be used to supply air to the interior of the air spring 250, such as a manual pump operated by the rider. A valve communicates with the interior of the air spring 250 via an outlet, for releasing air from the interior of the spring 250 to the atmosphere. It is contemplated that the valve may alternatively be any other suitable valve, such as a manually operated valve. It is contemplated that the inlet may alternatively function as both the inlet and the outlet, and that the valve may be a two-way valve capable of selectively communicating the interior of the air spring 250 with either the compressor or the atmosphere as required. It is contemplated that the left and right air springs 250 corresponding to the left and right suspension assemblies 208 may be supplied with air from the same compressor, and that air may be released from the left and right air springs 250 to the atmosphere via the same valve.

A position sensor (not shown) is connected between the frame 206 and the swing arm 232. The position sensor detects the relative position of the frame 206 and the swing arm 232, and sends an electronic signal to a controller (not shown) to indicate either the relative position of the frame 206 and the swing arm 232, or a change in the relative position. The controller is capable of sending a signal to either the compressor or the valve as a function of the electronic signal received from the position sensor, as will be described below in further detail. It is contemplated that the position sensor may alternatively be a mechanical indicator that indicates the relative position directly to the rider, for example a visible gauge or one or more reference heights indicated on the vehicle 200. A mechanical indicator would be suitable in the case where a manual pump is used by the rider to supply air to the interior of the air spring 250.

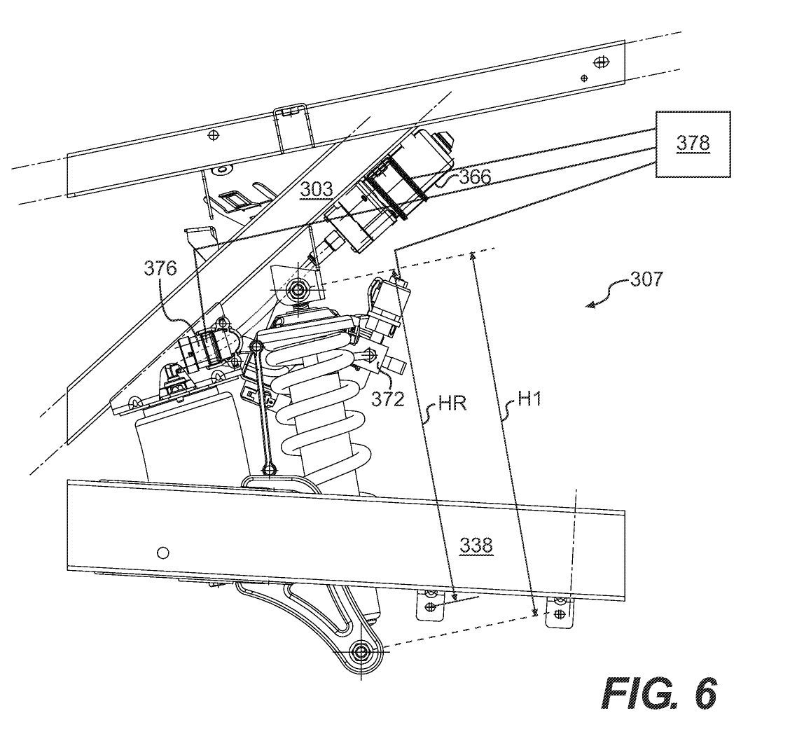

Referring back to FIG. 2, and referring also to FIGS. 6-9, the operation and adjustment of the suspension assembly 307 will now be described.

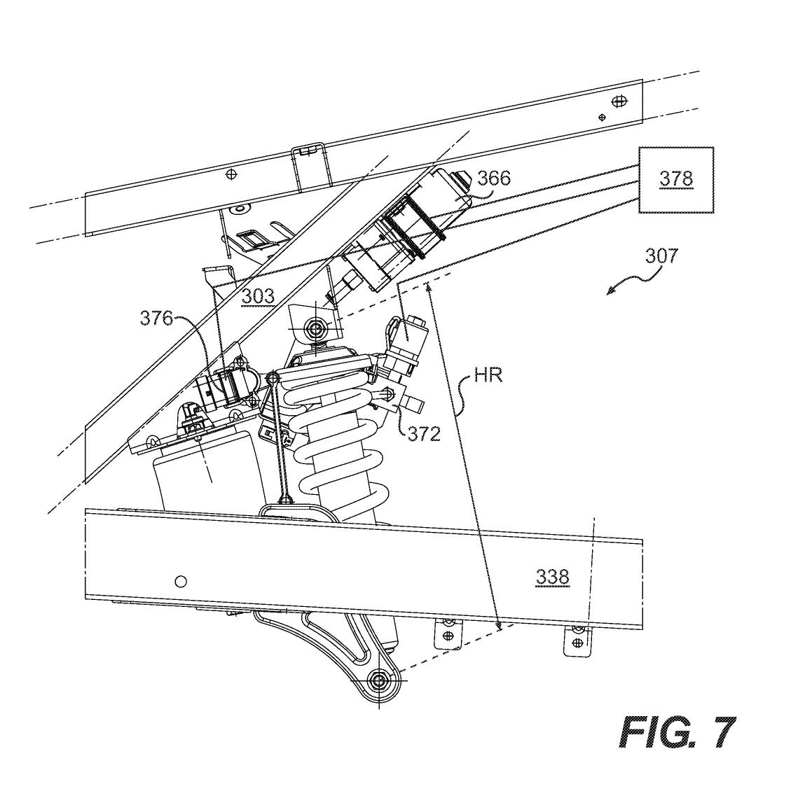

As previously mentioned, the swing arm 338 is pivotable relative to the frame 303 about the axis 340. When the vehicle 300 is at rest and there are no passengers or cargo disposed thereon, the suspension assembly 307 has an initial height H1 as seen in FIG. 6. When a single person of average weight sits on the seat 314, the suspension assembly 307 is compressed to a height HR as seen in FIG. 7. The suspension assembly 307 is preferably calibrated such that the height HR corresponds to a desired ride height of the vehicle 300, for which the suspension assembly 307 is calibrated to provide the desired ride characteristics and rider comfort. It should be understood that the height HR is merely an initial height of the suspension assembly 307 with the vehicle 300 at rest. As the vehicle 300 encounters bumps or obstacles, the swing arm 338 will pivot with respect to the frame 303 and the length of the suspension assembly 307 will expand or be compressed accordingly before eventually resuming its normal height HR.

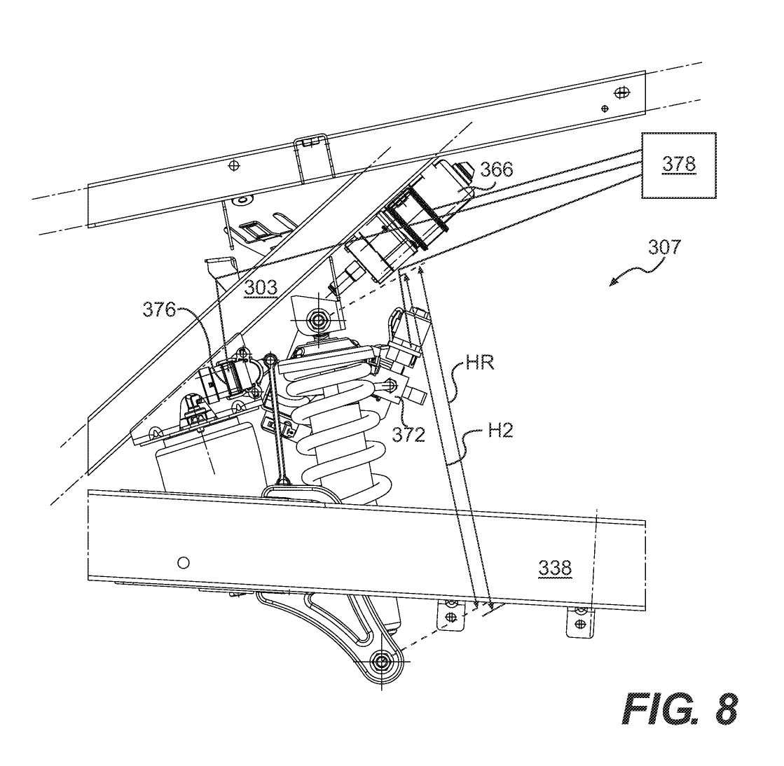

When additional weight is added to the vehicle 300, for example a second or third person seated on the seat 314, a heavier than average rider, or cargo placed on the vehicle 300, the suspension assembly 307 is compressed even further, to a height H2 lower than the desired ride height HR, as seen in FIG. 8. At the height H2, the suspension assembly 307 may not provide the desired ride characteristics for which it has been calibrated, because its initial position has changed from the desired ride height HR. In addition, the added compression of the suspension assembly 307 leaves a shorter stroke length before the suspension assembly 307 bottoms out when a bump or obstacle is encountered, potentially resulting in discomfort for the rider. The position sensor 376 detects the ride height H2 lower than the desired ride height HR, and sends a signal to the controller 378 indicative of the ride height H2. If the controller 378 determines that the height H2 is lower than the desired ride height by more than a threshold amount, the controller 378 activates the compressor 366 to supply air to the interior 370 of the air spring 356, causing the air spring 356 to expand. The expansion of the air spring 356 urges the frame 303 away from the swing arm 338, restoring the preferred ride height HR. In addition to restoring the preferred ride height HR, the expansion of the air spring 356 at least partially, if not fully, compensates for the effect of the additional weight on the natural frequency of the suspended mass. As a result, the suspension assembly 307 gives similar ride characteristics whether only a single person is on the vehicle 300 or additional passengers or cargo are added. In one embodiment, the compressor 366 stops supplying air to the interior 370 of the air spring 356 when the position sensor 376 indicates to the controller 378 that the desired ride height HR has been reached. It is contemplated that instead of a controller 378 activating a compressor 366, the rider may alternatively actuate the compressor 366 or a manual pump (not shown) until the desired ride height HR is reached.

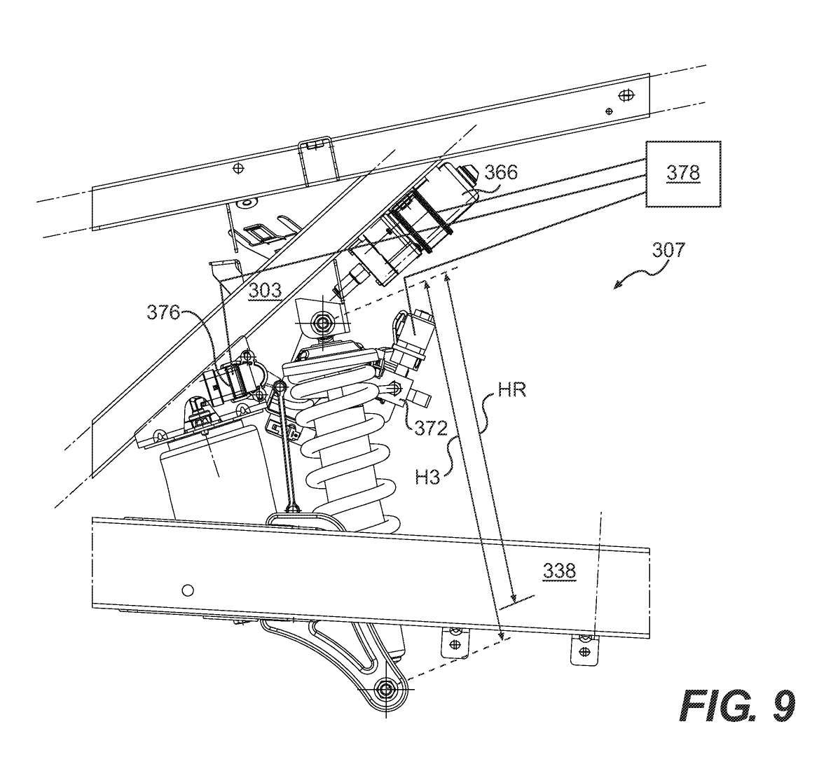

When weight is removed from the vehicle 300, for example when a passenger gets off the vehicle 300 or cargo is unloaded, the suspension assembly 307 becomes less compressed, and attains a height H3 higher than the desired ride height HR, as seen in FIG. 9. At the height H3, the suspension assembly 307 may not provide the desired ride characteristics for which it has been calibrated, because its initial position has changed from the desired ride height HR. In addition, the height of the vehicle and passengers are increased, potentially resulting in negative handling effects. The position sensor 376 detects the ride height H3 higher than the desired ride height HR, and sends a signal to the controller 378 indicative of the ride height H3. If the controller 378 determines that the height H3 is higher than the desired ride height by more than a threshold amount, the controller 378 activates the valve 372 to release air from the interior 370 of the air spring 356, reducing the air pressure therein. The air spring 356 exerts a reduced force upwardly on the frame 303, and the force of gravity urges the frame 303 toward the swing arm 338, decreasing the ride height. In one embodiment, the compressor 366 allows the valve 372 to close when the position sensor 376 indicates to the controller 378 that the desired ride height HR has been reached. It is contemplated that instead of a controller 378 activating a valve 372, the rider may alternatively actuate a manually operated valve until the desired ride height is reached.

It should be understood that a similar arrangement to those described above could be applied to the suspension system of any vehicle, for example a vehicle having the seat suspended above the frame of the vehicle.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

What is claimed is:

1. An adjustable height suspension system for a vehicle, comprising:
a frame;
a pivot arm having a first end pivotably connected to the frame, the pivot arm being pivotable with respect to the frame about a pivot axis, the adjustable height suspension system comprising:
a shock absorber assembly having a first end connected to the frame at a first connection point and a second end connected to the pivot arm at a second connection point, a length of the shock absorber assembly changing as the pivot arm pivots with respect to the frame, the shock absorber assembly comprising a shock absorber;
an air spring having a first end connected to the frame at a third connection point and a second end connected to the pivot arm at a fourth connection point, a length of the air spring changing as the pivot arm pivots with respect to the frame, the fourth connection point being closer to the pivot axis than the second connection point, the air spring having an interior, the air spring having at least one inlet and at least one outlet provided by at least one opening; and
a valve selectively communicating the interior of the air spring to the atmosphere via the outlet.

2. The adjustable height suspension system of claim 1, wherein the third connection point is closer to the pivot axis than the first connection point.

3. The adjustable height suspension system of claim 1, further comprising a compressor communicating with the interior of the air spring via the inlet to supply air to the interior of the air spring.

4. The adjustable height suspension system of claim 3, further comprising a position sensor connected to the vehicle, the position sensor being operative to detect a relative position of the frame and the pivot arm.

5. The adjustable height suspension system of claim 4, further comprising a controller connected to the vehicle, the controller being operative to receive a signal from the position sensor indicative of the relative position of the frame and the pivot arm, the controller selectively activating one of the valve and the compressor at least in part as a function of the signal.

6. The adjustable height suspension system of claim 5, wherein:
the controller activates the valve when the signal received is indicative of a ride height higher than a predetermined ride height; and
the controller activates the compressor when the signal received is indicative of a ride height lower than a predetermined ride height.

7. The adjustable height suspension system of claim 6, wherein:
the controller activates the valve when the signal received is indicative of a ride height higher than the predetermined ride height by a first predetermined threshold height; and
the controller activates the compressor when the signal received is indicative of a ride height lower than the predetermined ride height by a second predetermined threshold height.

8. The adjustable height suspension system of claim 3, wherein the valve provides selective communication between the compressor and the interior of the air spring.

9. The adjustable height suspension system of claim 1, wherein the pivot arm has a second end opposite the first end, the second end being adapted to connect to a wheel.

10. An adjustable height suspension system for a vehicle, comprising:
a frame;
first and second pivot arms, each pivot arm having a first end pivotably connected to the frame, the first and second pivot arms being pivotable with respect to the frame about respective first and second pivot axes, the adjustable height suspension system comprising:
a first shock absorber assembly having a first end connected to the frame at a first connection point and a second end connected to the first pivot arm at a second connection point, a length of the first shock absorber assembly changing as the first pivot arm pivots with respect to the frame, the first shock absorber assembly comprising a first shock absorber;
a first air spring having a first end connected to the frame at a third connection point and a second end connected to the first pivot arm at a fourth connection point, a length of the first air spring changing as the first pivot arm pivots with respect to the frame, the fourth connection point being closer to the first pivot axis than the second connection point, the first air spring having an interior, the first air spring having at least one first inlet and at least one first outlet provided by at least one first opening;
a second shock absorber assembly having a first end connected to the frame at a fifth connection point and a second end connected to the second pivot arm at a sixth connection point, a length of the second shock absorber assembly changing as the second pivot arm pivots with respect to the frame, the second shock absorber assembly comprising a second shock absorber;
a second air spring having a first end connected to the frame at a seventh connection point and a second end connected to the second pivot arm at an eighth connection point, a length of the second air spring changing as the second pivot arm pivots with respect to the frame, the eighth connection point being closer to the second pivot axis than the sixth connection point, the second air spring having at least one second inlet and at least one second outlet provided by at least one second opening; and
at least one valve selectively communicating the interior of the first and second air springs to the atmosphere via the first and second outlets, respectively.

11. The adjustable height suspension system of claim 10, wherein:
the third connection point is closer to the first pivot axis than the first connection point; and
the seventh connection point is closer to the second pivot axis than the fifth connection point.

12. The adjustable height suspension system of claim 10, further comprising a compressor communicating with the interiors of the first and second air springs via the first and second inlets respectively, to supply air to the interiors of the first and second air springs.

13. The adjustable height suspension system of claim 12, further comprising:
a first position sensor connected to the vehicle, the first position sensor being operative to detect a relative position of the frame and the first pivot arm; and
a second position sensor connected to the vehicle, the second position sensor being operative to detect a relative position of the frame and the second pivot arm.

14. The adjustable height suspension system of claim 13, further comprising a controller connected to the vehicle, the controller being operative to receive a signal from each position sensor indicative of the relative position of the frame and the corresponding pivot arm, the controller selectively activating one of the valve and the compressor at least in part as a function of the signal.

15. The adjustable height suspension system of claim 14, wherein:
the controller activates the valve when the signal received is indicative of a ride height higher than a predetermined ride height; and
the controller activates the compressor when the signal received is indicative of a ride height lower than a predetermined ride height.

16. The adjustable height suspension system of claim 16, wherein:
the controller activates the valve when the signal received is indicative of a ride height higher than the predetermined ride height by a first predetermined threshold height; and
the controller activates the compressor when the signal received is indicative of a ride height lower than the predetermined ride height by a second predetermined threshold height.

17. The adjustable height suspension system of claim 12, wherein the valve provides selective communication between the compressor and the interior of the first and second air springs.

18. The adjustable height suspension system of claim 10, wherein each pivot arm has a second end opposite the first end, the second end being adapted to connect to a wheel.

19. The adjustable height suspension system of claim 10, wherein the at least one valve is a single valve.
